(19) United States
(12) Patent Application Publication
(10) Pub. No.: US 2010/0196769 A1
(43) Pub. Date: Aug. 5, 2010

(54) FUEL CELL SYSTEM

(76) Inventors: Young-Seung Na, Suwon-si (KR); In-Seob Song, Suwon-si (KR); Young-Soo Joung, Seoul (KR); Mi-Jeong Song, Suwon-si (KR); Hye-Jung Cho, Anyang-si (KR)

Correspondence Address: CHRISTIE, PARKER & HALE, LLP, PO BOX 7068, PASADENA, CA, 91109-7068, US

(21) Appl. No.: 12/634,562

(22) Filed: Dec. 9, 2009

Related U.S. Application Data
(60) Provisional application No. 61/150,074, filed on Feb. 5, 2009.

(51) Int. Cl. H01M 8/04; H01M 2/00

(52) U.S. Cl. 429/415; 429/462

(57) ABSTRACT

A fuel cell system according to exemplary embodiments of the present invention includes a fuel cell stack that generates electrical energy through the electrochemical reaction of fuel and oxidant, a fuel supply unit for supplying the fuel to the fuel cell stack, and an oxidant supply unit for supplying the oxidant to the fuel cell stack. The fuel supply unit includes a fuel permeation membrane between a space where fuel recovered from the fuel cell stack is positioned and a space where stored fuel is positioned. The fuel cell system enables easy control of the concentration of fuel supplied to the fuel cell stack.

### CROSS-REFERENCE TO RELATED PATENT APPLICATION

This application claims priority to and the benefit of U.S. Provisional Application Ser. No. 61/150,074, filed on Feb. 5, 2009 and titled “FUEL CELL SYSTEM,” the entire content of which is incorporated herein by reference

### BACKGROUND OF THE INVENTION

1. Field of the Invention

The present invention relates to fuel cell systems.

2. Description of the Related Art

Fuel cells are devices that electrochemically generate power using fuel (hydrogen or reformed gas) and oxidant (oxygen or air). The fuel (hydrogen or reformed gas) and oxidant (oxygen or air) are continuously supplied from outside the cell and are converted into electrical energy by an electrochemical reaction.

Pure oxygen or air containing a large amount of oxygen is used as the oxidant of the fuel cell. Pure hydrogen or fuel containing a large amount of hydrogen, which is generated by reforming hydrocarbon-based fuel (LNG, LPG, CH₃OH, etc.) is used as the fuel.

For ease of explanation and comprehension, a direct methanol fuel cell (DMFC) will be primarily described. The direct methanol fuel cell supplies a high-concentration methanol fuel to a fuel cell stack to generate electricity by reaction with oxygen. The direct methanol fuel cell uses a high-concentration fuel to increase energy weight density. When using the high-concentration fuel, the direct methanol fuel cell mixes the high-concentration fuel with recovered fuel and supplies a fuel with the proper concentration to the fuel cell stack.

Schemes for supplying the fuel to the fuel cell stack are classified into active schemes and passive schemes. In an active scheme, the fuel is supplied to the fuel cell stack using a fuel pump. In a passive scheme, the fuel is supplied to the fuel cell stack by pressurizing a cartridge using a capillary phenomenon or an exhaust gas.

The active scheme advantageously controls the concentration and flow rate of the fuel in accordance with the conditions of the fuel cell system. However, a disadvantage of the active scheme is that devices such as the fuel pump, a recycling pump, a flow rate sensor, a concentration sensor, etc. are required, thereby increasing the volume, weight, and power consumption of the fuel cell system. In particular, a high-precision pump is required to control the flow rate with precision, but such a high-precision pump is expensive and easily malfunctions depending on changes in the flow rate.

In contrast, the passive scheme can decrease the volume, weight, and power consumption of the fuel cell system because the fuel is supplied using only a passive physical phenomenon without a pump or a sensor. However, the flow rate cannot be controlled with precision, thereby significantly decreasing efficiency of the fuel cell system or causing permanent damage to the fuel cell system. Further, the passive scheme currently cannot control large flow rates, making it difficult to adopt the passive scheme in a high-output fuel cell system.

The information disclosed in this Background section is presented solely to enhance understanding of the background of the invention, and therefore may contain information that is not part of the prior art known to persons of ordinary skill in the art.

### SUMMARY OF THE INVENTION

According to one embodiment of the present invention, a fuel cell system is supplied with fuel using low power.

An exemplary embodiment of the present invention provides a fuel cell system including a fuel cell stack, a fuel supply unit for supplying fuel to the fuel cell stack, and an oxidant supply unit for supplying oxidant to the fuel cell stack. The fuel cell stack generates electrical energy through an electrochemical reaction of the fuel and the oxidant.

The fuel supply unit includes a fuel permeable membrane installed between a fuel recovery chamber and a fuel storage chamber. The fuel storage chamber houses a fuel with a first concentration, and the fuel recovery chamber allows passage of fuel recovered from the fuel cell stack having a second concentration. The first concentration is higher than the second concentration. The fuel permeable membrane may be a reverse osmosis membrane that is selectively permeable to the stored fuel, i.e., it allows only the stored fuel (having the first concentration) to pass over the membrane. The fuel supply unit may include a fuel storage chamber that expands and contracts depending on changes in the volume of the stored fuel.

The fuel storage chamber houses the stored fuel and includes a passage connected to the fuel recovery chamber, which includes a passage through which recovered fuel circulates. The fuel permeable membrane may be disposed between the fuel storage chamber and the fuel recovery chamber.

In an alternative embodiment, a concentration controller may be connected to the fuel storage chamber. The concentration controller may include a second fuel storage chamber, the fuel permeable membrane and the fuel recovery chamber. The second fuel storage chamber receives the fuel having a first concentration from the first fuel storage chamber, and the fuel permeable membrane is installed between the second fuel storage chamber and the recovery chamber.

According to embodiments of the present invention, fuel can be stably supplied to the fuel cell stack while minimizing power consumption at the time of fuel delivery. Further, production costs can be reduced by decreasing the number of components in the system.

### BRIEF DESCRIPTION OF THE DRAWINGS

FIG. 1 is a schematic of a fuel cell system according to an embodiment of the present invention.

FIG. 2 is an exploded perspective view of the structure of the fuel cell stack of the fuel cell system of FIG. 1.

FIG. 3 is an exploded perspective view of a concentration controller according to an embodiment of the present invention.

FIG. 4 is a schematic of a fuel cell system according to another embodiment of the present invention.

FIG. 5 is a cross-sectional view of a concentration controller according to an embodiment of the present invention.

FIG. 6 is a graph depicting the relationship between fuel concentration and the flow rate of recovered fuel in a fuel cell system according to an embodiment of the present invention.

FIG. 7 is a graph illustrating the average and standard deviations of fuel concentration depending on the flow rate of the recovered fuel in a fuel cell system according to an embodiment of the present invention.

### DETAILED DESCRIPTION OF THE EMBODIMENTS

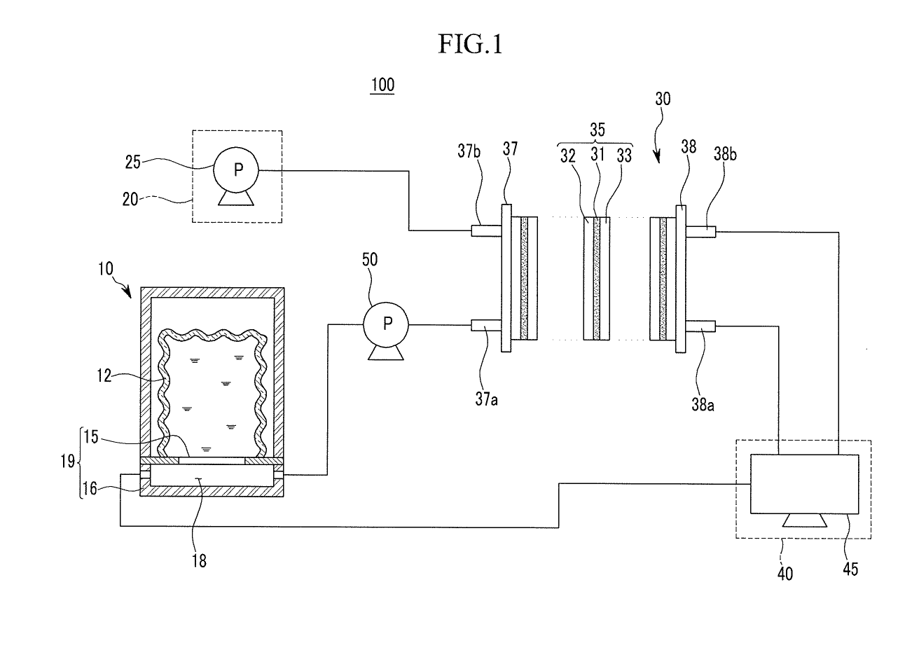

FIG. 1 is a schematic of a configuration of a fuel cell system according to an exemplary embodiment of the present invention. Referring to FIG. 1, the fuel cell system 100 may be a direct methanol fuel cell (DMFC), which generates electrical energy by direct reaction of methanol and oxygen. However, the present invention is not limited to DMFCs. For example, the fuel cell system according to exemplary embodiments of the invention may be direct oxidation fuel cells, which react a liquid or gas hydrogen-containing fuel (such as ethanol, LPG, LNG, gasoline, butane gas, etc.) with oxygen.

The fuel used in the fuel cell system 100 is generally a hydrocarbon-based fuel in a liquid or gas state, such as methanol, ethanol, natural gas, LPG, etc.

In addition, the fuel cell system 100 may use oxygen gas stored in an outer storage container or air as the oxidant that reacts with the hydrogen-based fuel.

According to an exemplary embodiment, the fuel cell system 100 includes a fuel cell stack 30 for reacting the fuel and oxidant to generate power, a fuel supply unit 10 for supplying the fuel to the fuel cell stack 30, an oxidant supply unit 20 for supplying the oxidant to the fuel cell stack 30, and a recovery unit 40 for recovering non-reacted fuel and moisture discharged from the fuel cell stack 30 and re-supplying the non-reacted fuel and the moisture to the fuel cell stack 30.

The fuel supply unit 10 is connected to the fuel cell stack 30 and includes a fuel storage chamber 12 and a concentration controller 19 connected to the fuel storage chamber 12. The fuel supply unit 10 will be described below in more detail.

The oxidant supply unit 20 is connected to the fuel cell stack 30 and includes an oxidant pump 25 that draws in external air and supplies the external air to the fuel cell stack 30.

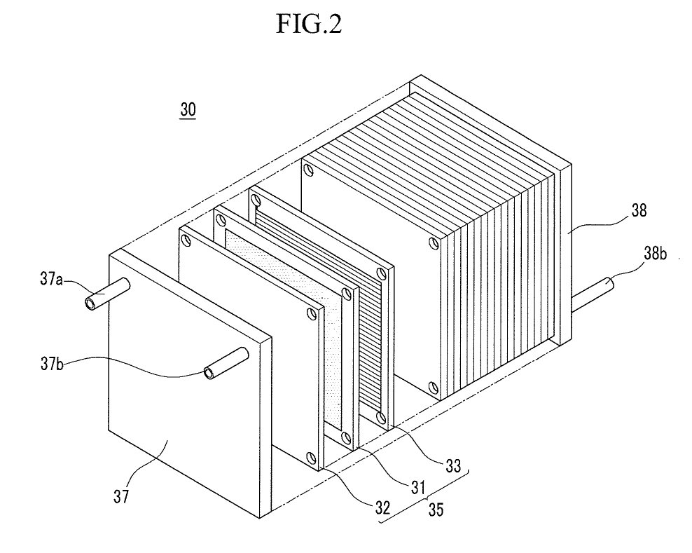

FIG. 2 is an exploded perspective view of the structure of the fuel cell stack shown in FIG. 1. Referring to FIGS. 1 and 2, the fuel cell stack 30 in the fuel cell system 100 includes a plurality of electricity generating units 35, which generate electrical energy by inducing oxidation and reduction reactions of the fuel and the oxidant. Each of the electricity generating units 35 represents a unit cell that generates electricity and includes a membrane-electrode assembly (MEA) 31 (which oxidizes and reduces oxygen in the fuel and the oxidant), and separators (also referred to as a bipolar plate) 32 and 33 (which supply the fuel and the oxidant to the membrane-electrode assembly).

In the electricity generating unit 35, the separators 32 and 33 are disposed at both sides, around the membrane-electrode assembly 31. The membrane-electrode assembly 31 includes an electrolyte membrane disposed at its center, a cathode electrode disposed at one side of the electrolyte membrane, and an anode electrode disposed at the other side of the electrolyte membrane.

The separators 32 and 33 are close to each other, and the membrane-electrode assembly 31 is disposed between the separators. The separators 32 and 33 each have a fuel passage and an air passage at both sides of the membrane-electrode assembly 31. The fuel passage is disposed at the anode electrode of the membrane-electrode assembly 31, and the air passage is disposed at the cathode electrode of the membrane-electrode assembly 31. In addition, an electrolyte membrane enables ion exchange, in which hydrogen ions generated from the anode electrode move to the cathode electrode and are bound to oxygen at the cathode electrode to generate water.

In the fuel cell system 100, the plurality of electricity generating units 35 are successively arranged to form the fuel cell stack 30. End plates 37 and 38 for fixing the electricity generating units in the fuel cell stack 30 are installed at the outermost parts of the fuel cell stack 30.

A first inlet 37a for supplying the fuel to the fuel cell stack 30, and a second inlet 37b for supplying the oxidant to the stack are formed in one end plate 37. Further, a first outlet 38a for discharging non-reacted fuel remaining after reaction at the anode electrode of the membrane-electrode assembly 31, and a second outlet 38b for discharging moisture generated by the bonding reaction of hydrogen and oxygen at the cathode electrode of the membrane-electrode assembly 31 and non-reacted air are formed in the other end plate 38.

The recovery unit 40 includes a gas-liquid separator 45 that collects fluids discharged from the outlets 38a and 38b and separates the fluids into gas and liquid. The gas-liquid separator 45 is installed at the outlet end of the fuel cell stack 30 and may include a centrifugal pump or an electro-kinetic pump. The gas-liquid separator 45 mixes the non-reacted fuel discharged from the first outlet 38a with the non-reacted air and moisture discharged from the second outlet 38b, and separates the mixed non-reacted fuel and air into liquid and gas. The gas-liquid separator 45 discharges the gas to the outside and supplies the recovered fuel to the fuel supply unit 10.

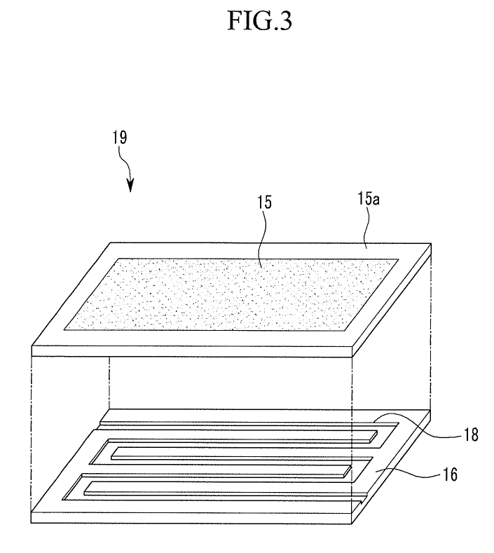

FIG. 3 is an exploded perspective view of a concentration controller according to an exemplary embodiment of the present invention. Referring to FIGS. 1 and 3, the fuel supply unit according to an exemplary embodiment includes a fuel storage chamber 12 and a concentration controller 19. The concentration controller 19 includes a fuel permeable membrane 15 and a fuel recovery chamber 16 which is installed in contact with a surface of the fuel permeable membrane 15.

The fuel storage chamber 12 may have a pouch or bellows shape that can expand and contract depending on changes in the volume of the fuel. As the fuel is consumed, the volume of the fuel in the fuel storage chamber 12 gradually decreases. As a result, the inner space in the chamber also gradually decreases, thereby transforming the fuel storage chamber 12.

The fuel stored in the fuel storage chamber 12 is pressurized. When the volume of fuel decreases, the fuel storage chamber 12 is contracts, which enables the pressure acting on the fuel to be maintained constant.

The fuel permeable membrane 15 is connected to an opening of the fuel storage chamber 12. The fuel permeable membrane 15 is selectively permeable and allows permeation of a fuel depending on a difference in concentration between two fuels (e.g., the fuel stored in the fuel storage chamber and the fuel provided in the fuel recovery chamber).

The fuel permeable membrane 15 may be made of various materials having high permeability to the fuel. For example, the fuel permeable membrane 15 may be a perfluorosulfonic acid membrane, e.g. Nafion 112 (available from E.I. du Pont de Nemours, Co.) having high permeability to methanol. The fuel permeable membrane 15 may include a frame 15a on its periphery to support the fuel permeable membrane 15. The fuel permeable membrane 15 is installed between a high-concentration fuel (e.g., the fuel stored in the fuel storage chamber) and a low-concentration fuel (e.g., the fuel circulating through the fuel recovery chamber). The membrane 15 allows permeation of the high concentration fuel through the membrane to the low-concentration fuel. In that regard, the fuel permeable membrane 15 may be regarded as a kind of reverse osmosis membrane that selectively permeates the fuel.

The fuel recovery chamber 16 has a passage through which the recovered fuel circulates, and is installed in communication with a surface of the fuel permeable membrane 15. The fuel recovery chamber 16 may be plate shaped, and may have a fuel passage 18 through which the recovered fuel circulates positioned on a surface of the fuel recovery chamber 16. The fuel passage 18 may have any suitable shape, for example, the passage may have a serpentine groove structure. The recovered fuel (which contains a large amount of moisture) is transferred to the fuel recovery chamber from the recovery unit 40 and circulates in the fuel passage 18. The serpentine groove structure is a structure in which grooves zig-zag across the surface of the fuel recovery chamber to form a serpentine shape, such as that depicted in FIG. 3.

The recovered fuel circulates through the fuel recovery chamber in contact with the fuel permeable membrane 15. As the recovered fuel moves through the fuel recovery chamber, the stored fuel from the fuel storage chamber (which is high in concentration and pressure) moves through the fuel permeable membrane 15 to the fuel passage 18. When the stored fuel moves through the membrane 15 to the recovered fuel, the stored fuel and the recovered fuel mix to thereby obtain a proper-concentration fuel. The proper-concentration fuel is then supplied to the fuel cell stack 30 by means of a fuel transfer pump 50.

The concentration of the proper-concentration fuel may be controlled by adjusting the area and time over which the stored fuel and the recovered fuel contact the fuel permeation membrane 15, and adjusting the flow rate of the recovered fuel.

According to an exemplary embodiment of the present invention, the concentration of the proper-concentration fuel is controlled by adjusting the contact between the high-concentration fuel (e.g., the stored fuel) and the low-concentration fuel (e.g., the recovered fuel) such that the proper-concentration fuel can be supplied to the fuel cell stack 30. As a result, components such as the pump, concentration sensor, and flow rate sensor may be removed, and the fuel can still be stably supplied to the stack. Further, an additional fuel pump is not installed since a large amount of fuel can be supplied to the fuel cell stack based on the contact area of the stored fuel and the recovered fuel.

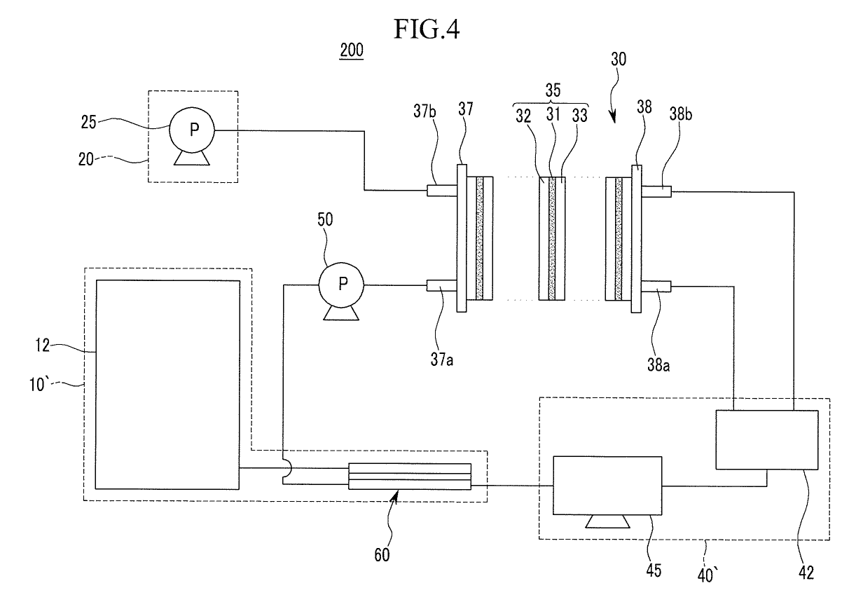

FIG. 4 is a schematic of a fuel cell system according to an alternative exemplary embodiment of the present invention. Referring to FIG. 4, the fuel cell system 200 includes a fuel cell stack 30 for generating electricity from the reaction of fuel and oxidant, a fuel supply unit 10′ for supplying fuel to the fuel cell stack 30, an oxidant supply unit 20 for supplying oxidant to the fuel cell stack 30, and a recovery unit 40′ for recovering non-reacted fuel and air discharged from the fuel cell stack 30 and re-supplying the non-reacted fuel and air to the fuel cell stack 30.

The fuel cell system 200 has the same configuration as the fuel cell system 100 except for the fuel supply unit 10′ and the recovery unit 40′. The recovery unit 40′ includes a heat exchanger 42 for receiving and cooling oxidant containing non-reacted fuel and moisture discharged from the fuel cell stack 30, and a gas-liquid separator 45 for separating fluids discharged from the heat exchanger 42 into gas and liquid.

The heat exchanger 42 serves to cool and condense high-temperature fluids discharged from the fuel cell stack 30. The gas-liquid separator 45 separates the condensed fluids into gas and liquid, discharges the gas to the outside and supplies the liquid to the fuel supply unit 10.

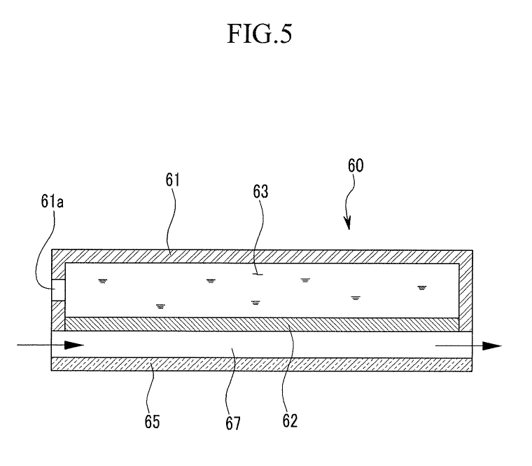

FIG. 5 is a cross-sectional view of a concentration controller according to an exemplary embodiment of the present invention. Referring to FIGS. 4 and 5, the fuel supply unit 10′ includes a first fuel storage chamber 12 and a concentration controller 60 connected to the first fuel storage chamber 12. The first fuel storage chamber 12 may have any suitable structure for storing fuel. Alternatively, the first fuel storage chamber 12 may have a replaceable cartridge that includes the fuel.

The concentration controller 60 includes a second fuel storage chamber 61 that is connected to the first fuel storage chamber 12 by a pipe and has a space in which the stored fuel circulates. The concentration controller 60 also includes a fuel recovery chamber 65 that has a fuel passage 67 through which the recovered fuel circulates. In addition, the concentration controller 60 includes a fuel permeable membrane 62 between the second fuel storage chamber 61 and the fuel recovery chamber 65.

The second fuel storage chamber 61 is substantially plate shaped and has a fuel passage 63 in the form of a groove. Further, an inlet 61a is formed at one end of the second fuel storage chamber 61 in communication with the first fuel storage chamber 12. The other end of the second fuel storage chamber 61 is closed. Therefore, the second fuel storage chamber 61 has the same internal pressure as the first fuel storage chamber 12.

The fuel passage 63 in the second fuel storage chamber 61 contacts the fuel permeable membrane 62 such that the stored fuel flowing in from the first fuel storage chamber 12 is discharged through the fuel permeable membrane 62.

The fuel recovery chamber 65 is substantially plate shaped. The fuel passage 67 through which the recovered fuel circulates is formed on a surface of the fuel recovery chamber 65 facing the fuel permeable membrane 62. Both ends of the fuel passage 67 are open. One end of the passage is connected to the recovery unit 40′ and receives the recovered fuel, while the other end of the passage is connected to the fuel cell stack 30 and supplies the proper-concentration fuel to the fuel cell stack 30.

The fuel permeable membrane 62 may be a reverse osmosis membrane that selectively permeates and transfers fuel from the second fuel storage chamber to the fuel recovery chamber, as described above with respect to the embodiment depicted in FIG. 1. Therefore, the stored fuel is mixed with the recovered fuel through the fuel permeable membrane 62. In this process, the concentration of the fuel is properly controlled.

According to exemplary embodiments of the present invention, the concentration of the fuel supplied to the fuel cell stack 30 can be easily controlled using a concentration controller 60 connected (e.g., via a pipe) to the first fuel storage chamber 12.

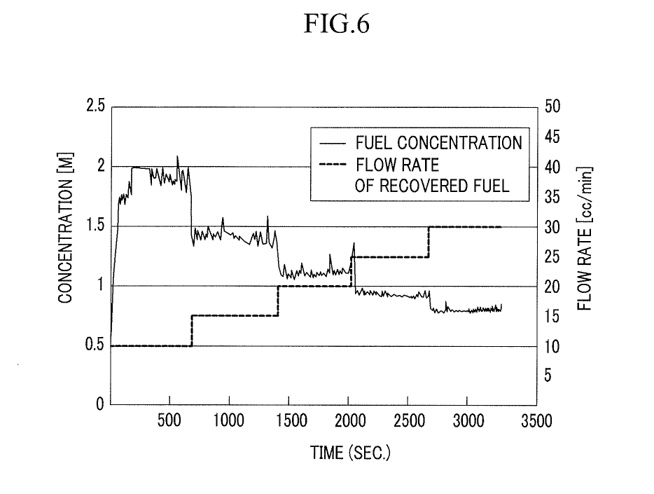

FIG. 6 is a graph illustrating the relationship between fuel concentration and flow rate of the recovered fuel in a fuel cell system according to an exemplary embodiment of the present invention. As shown in FIG. 6, as the flow rate of the recovered fuel increases, the concentration of the fuel being supplied to the fuel cell stack decreases in stages. When the flow rate of the recovered fuel is 20 cc/min or more, the concentration of the fuel stays remarkably constant.

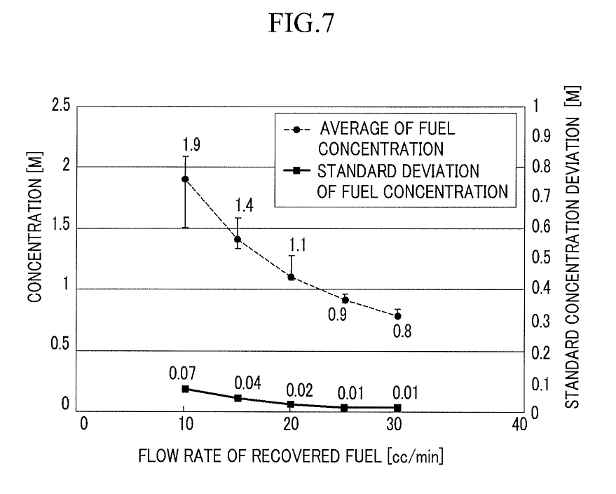

FIG. 7 is a graph illustrating the average and standard deviations of fuel concentration depending on the flow rate of the recovered fuel in a fuel cell system according to an exemplary embodiment of the present invention. As shown in FIG. 7, when the flow rate of the recovered fuel is 20 cc/min or more, the standard deviation of the fuel concentration stays at 0.02 M or less. Therefore, according to exemplary embodiments of the present invention, it is possible to achieve the same level of fuel concentration stability by controlling the flow rate of the recovered fuel as is achieved by using a high-precision pump.

While this invention has been described in connection with certain exemplary embodiments, those of ordinary skill in the art understand that various modifications and changes can be made to the described embodiments without departing from the spirit and scope of the invention, as defined by the appended claims.

What is claimed is:

1. A fuel supply unit for supplying fuel to a fuel cell stack of a fuel cell system, the fuel supply unit comprising:
a fuel storage chamber configured to house a stored fuel having a first concentration of fuel;
a fuel recovery chamber configured to allow passage of a recovered fuel having a second concentration of fuel, wherein the second concentration is lower than the first concentration; and
a fuel permeable membrane between the fuel storage chamber and the fuel recovery chamber, the fuel permeable membrane configured to pass the stored fuel to the fuel recovery chamber.

2. The fuel supply unit according to claim 1, wherein the fuel storage chamber has a pouch or bellows shape.

3. The fuel supply unit according to claim 1, wherein the fuel permeable membrane comprises a perfluorosulfonic acid membrane.

4. The fuel supply unit according to claim 1, wherein the fuel recovery chamber comprises grooves through which the recovered fuel flows.

5. The fuel supply unit according to claim 4, wherein the grooves comprise a serpentine groove shape.

6. The fuel supply unit according to claim 1, wherein the fuel storage chamber comprises a first fuel storage chamber, wherein the fuel supply unit further comprises a concentration controller comprising a second fuel storage chamber, the fuel recovery chamber and the fuel permeable membrane, wherein the second fuel storage chamber is configured to receive the stored fuel from the first fuel storage chamber, and wherein the fuel permeable membrane is between the second fuel storage chamber and the fuel recovery chamber.

7. A fuel supply unit for supplying fuel to a fuel cell stack of a fuel cell system, the fuel supply unit comprising:
a first fuel storage chamber configured to house a stored fuel having a first concentration of fuel; and
a concentration controller comprising:
a second fuel storage chamber configured to receive the stored fuel from the first fuel storage chamber;
a fuel recovery chamber configured to allow passage of a recovered fuel having a second concentration of fuel, wherein the second concentration is lower than the first concentration; and
a fuel permeable membrane between the second fuel storage chamber and the fuel recovery chamber, the fuel permeable membrane configured to allow passage of the stored fuel to the fuel recovery chamber.

8. The fuel supply unit according to claim 7, wherein the fuel permeable membrane comprises a perfluorosulfonic acid membrane.

9. A fuel cell system, comprising:
a fuel cell stack configured to react fuel with oxidant to generate electrical energy;
a fuel supply unit configured to supply fuel to the fuel cell stack, the fuel supply unit comprising:
a fuel storage chamber configured to house a stored fuel having a first concentration of fuel,
a fuel recovery chamber configured to allow passage of a recovered fuel having a second concentration of fuel, wherein the second concentration is lower than the first concentration, and
a fuel permeable membrane between the fuel storage chamber and the fuel recovery chamber, the fuel permeable membrane being configured to allow passage of the stored fuel to the fuel recovery chamber; and
an oxidant supply unit configured to supply oxidant to the fuel cell stack.

10. The fuel cell system according to claim 9, wherein the fuel storage chamber has a pouch or bellows shape.

11. The fuel cell system according to claim 9, wherein the fuel permeable membrane comprises a perfluorosulfonic acid membrane.

12. The fuel cell system according to claim 9, wherein the fuel recovery chamber comprises grooves through which the recovered fuel is configured to flow.

13. The fuel cell system according to claim 9, further comprising a fuel transfer pump configured to deliver fuel from the fuel recovery chamber to the fuel cell stack.

14. The fuel cell system according to claim 9, further comprising a fuel recovery unit configured to recover unreacted fuel from the fuel cell stack and deliver the recovered fuel to the fuel recovery chamber of the fuel supply unit.

15. A fuel cell system, comprising:
a fuel cell stack configured to react fuel with oxidant to generate electrical energy;
a fuel supply unit configured to supply fuel to the fuel cell stack, the fuel supply unit comprising:
a first fuel storage chamber configured to house a stored fuel having a first concentration of fuel, and
a concentration controller comprising:
a second fuel storage chamber configured to receive the stored fuel from the first fuel storage chamber,
a fuel recovery chamber configured to allow passage of a recovered fuel having a second concentration of fuel, wherein the second concentration is lower than the first concentration, and
a fuel permeable membrane between the second fuel storage chamber and the fuel recovery chamber, the fuel permeable membrane being configured to allow passage of the stored fuel to the fuel recovery chamber; and
an oxidant supply unit configured to supply oxidant to the fuel cell stack.

16. The fuel cell system according to claim 15, further comprising a fuel recovery unit configured to recover unreacted fuel from the fuel cell stack and deliver the recovered fuel to the fuel recovery chamber of the fuel supply unit.

17. The fuel cell system according to claim 16, wherein the fuel recovery unit comprises a heat exchanger and a gas-liquid separator.

18. The fuel cell system according to claim 15, wherein the fuel permeable membrane comprises a perfluorosulfonic acid membrane.

19. The fuel cell system according to claim 15, further comprising a fuel transfer pump configured to deliver fuel from the fuel recovery chamber to the fuel cell stack.
